(19) United States
(12) Patent Application Publication
(10) Pub. No.: US 2015/0004449 A1
(43) Pub. Date: Jan. 1, 2015

(54) TEMPERATURE CONTROL APPARATUS AND METHOD OF BATTERY SYSTEM FOR VEHICLE

(71) Applicants: Kia Motors Corporation, Seoul (KR); Hyundai Motor Company, Seoul (KR)

(72) Inventors: Do Kyoung Lim, Gwangmyeong (KR); Suk Hyung Kim, Gunpo (KR); Dal Kim, Suwon (KR); Jae Hoon Choi, Gunpo (KR)

(73) Assignees: KIA MOTORS CORPORATION, Seoul (KR); HYUNDAI MOTOR COMPANY, Seoul (KR)

(21) Appl. No.: 14/041,140

(22) Filed: Sep. 30, 2013

(30) Foreign Application Priority Data
Jun. 28, 2013 (KR) 10-2013-0075172

(51) Int. Cl. H01M 10/625; H01M 10/6566; H01M 10/6564

(52) U.S. Cl. CPC H01M 10/5016; H01M 10/5069; H01M 10/5073
USPC 429/62

(57) ABSTRACT

A temperature control apparatus of a battery system and method for a vehicle are provided that include a case, a cooling fan, a battery module, a driving mechanism, a temperature sensor; and a controller. The temperature control apparatus allows temperature equilibrium of a battery to be reached efficiently with a simplified structure in a decreased time period by checking the temperature deviation between battery modules.

### CROSS-REFERENCE TO RELATED APPLICATION

This application claims under 35 U.S.C. §119(a) priority to Korean Patent Application No. 10-2013-0075172 filed on Jun. 28, 2013, the entire contents of which are incorporated herein by reference.

### BACKGROUND

(a) Technical Field

The present disclosure relates to a cooling device of a battery system and method for a vehicle, and more specifically, to a temperature control apparatus and method of a battery system for a vehicle.

(b) Background Art

Conventionally, gasoline and diesel have been used for driving internal combustion engines, causing atmospheric contamination. Accordingly, electrical vehicles (EV) that can be driven with motors or hybrid electrical vehicles (HEV), etc. that can be driven with internal combustion engines and motors, are capable of reducing the environment pollution.

However, when a motor is used as a power source, a vehicle is driven by operating a motor with an electrical power supplied from a battery that is mounted to a vehicle, however a battery produces heat during the process of charging and discharging, and when the heat is not efficiently removed the heat accumulates, causing damage to the battery, a risk of a fire, or an explosion due to the deterioration of the battery consequently.

Accordingly, a technology for cooling a battery has been developed and includes a secondary battery module that has one or more cell assemblies arranged as laminated layers of a plurality of mechanism cells, and a guide disposed at a side surface of the cell assemblies for distributing heat transfer material flowed in the cell assembly, at different flow amount according to the locations of the cell assembly to improve the efficiency of temperature control in a mechanism cell and minimize a temperature deviation among each mechanism cell by improving the distribution structure of heat transfer material. However, a need exists for a temperature control apparatus of a battery system for a vehicle and a method thereof that allows temperature equilibrium of a battery to be reached efficiently with a simple structure in a shorter time period by checking the temperature deviation between battery modules.

The invention disclosed in this background art is only for enhancement of understanding of the background of the invention and should not be taken as an acknowledgement or any form of suggestion that this information forms the prior art already known to a person skilled in the art.

### SUMMARY

The present invention provides a temperature control apparatus of a battery system and method for a vehicle that allows temperature equilibrium of a battery to be reached efficiently with a simpler structure in a decreased time period by checking the temperature deviation between battery modules.

In particular, the present invention provides a temperature control apparatus of a battery system for a vehicle that may include: a case that has a plurality of module mounting portions; a cooling fan installed to one side of the case and allows air to flow within the case; a battery module mounted to the module mounting portion and including a housing on an upper surface of which air vents formed through is provided, a plurality of battery cells separately mounted to an inner side of the housing and a predetermined space is disposed between the battery cells and the housing. In addition, a driving mechanism is disposed at the space portion of the battery module and in which baffles in a shape of plate are formed at locations corresponding to the air vents, respectively, wherein the baffle is connected to an actuator and is driven by the actuator to close or open the air vent. A temperature sensor is mounted to a battery module to measure a temperature and a controller may be configured to calculate a temperature deviation by identifying a maximum temperature battery module and a minimum temperature battery module based on the temperature of the battery module measured at the temperature sensor and may be configured to operate the driving mechanism based on the calculated temperature deviation.

The air vent of the housing of the battery module may be slit-shaped to be lengthy in the longitudinal direction of the housing wherein a plurality of the air vents may be spaced at a predetermined interval to form rows and columns The housing may be formed in a shape of a rectangular pole, in which apertures are formed for the surfaces of the battery cells, and the surfaces of the battery cells that are disposed on front-most surface and rear-most surface of the housing may be exposed. The space portion of the battery modules may be formed between the upper surface of the battery cell and inner side of the upper surface of the housing, and a driving mechanism may be at one side of the space portion.

A plurality of baffles that correspond to the air vents may be disposed within the driving mechanism, respectively, the plurality of baffles may be connected to one another with a link, and the plurality of baffles connected to the link may be driven by the actuators to close or open the air vents, respectively. The baffles may be slid by the linear movement of the link connected to the actuator when the actuator drives, to close or open the air vents. In addition, the baffles may be rotated around the link connected to the actuator as a hinge axis when the actuator drives, to close or open the air vents.

The controller may be configured to operate the driving mechanism of the minimum temperature battery module to close the air vents of the minimum temperature battery module, thereby blocking the air inflow therein, when the calculated temperature deviation is a first reference value of a predetermined level or greater. In addition, the controller may be configured to operate the driving mechanism of the minimum temperature battery module to close the air vents of the minimum temperature battery module, thereby blocking the air inflow therein, and to raise the stage of the cooling fan to a predetermined level, when the calculated temperature deviation is a second reference value of a predetermined level or greater.

Furthermore, a temperature control method of a battery system for a vehicle of the present invention, may include: measuring the temperatures of each battery module; identifying a maximum temperature battery module and a minimum temperature battery module based on the temperature measured in the measuring step, calculating a temperature deviation between two battery modules to compare whether the calculated temperature deviation is greater than the first reference value; and operating the driving mechanism of the minimum temperature battery modules to close the air vents, when the temperature deviation calculated in the comparing step is the first reference value or greater.

The comparing step may further include driving the cooling fan to raise the stage thereof when comparing whether the calculated temperature deviation is the second reference value or greater, and the calculated temperature deviation is the second reference value or greater. The second reference value in the comparing step may be set to be greater than the first reference value.

The controller may be configured to operate the actuator of the driving mechanism in the operating step, allowing the link that is connected to the actuator to be moved linearly and a plurality of baffles that are connected to the link to be slid to close the air vents, thereby blocking the air inflow. In addition, the controller may be configured to operate the actuator of the driving mechanism in the operating step, allowing a plurality of baffles that are connected to the link to be rotated around the link that is connected to the actuator as a hinge axis to close the air vents, thereby blocking the air inflow.

### BRIEF DESCRIPTION OF THE DRAWINGS

The above and other features of the present invention will now be described in detail with reference to certain exemplary embodiments thereof illustrated the accompanying drawings which are given herein below by way of illustration only, and thus are not limitative of the present invention, and wherein:

FIG. 1 is an exemplary block diagram showing a battery system according to an exemplary embodiment of the present invention;

FIG. 2 is an exemplary detailed view showing a battery of FIG. 1 according to an exemplary embodiment of the present invention;

FIG. 3 is an exemplary detailed view showing a battery module of FIG. 2 according to an exemplary embodiment of the present invention;

FIG. 4 is an exemplary view showing a sliding type driving mechanism before operating according to an exemplary embodiment of the present invention;

FIG. 5 is an exemplary view showing a sliding type driving mechanism of FIG. 4, after operation according to an exemplary embodiment of the present invention;

FIG. 6 is an exemplary view showing a hinge type driving mechanism before operation according to an exemplary embodiment of the present invention;

FIG. 7 is an exemplary view showing a hinge type driving mechanism of FIG. 6, after operation according to an exemplary embodiment of the present invention; and

FIG. 8 is an exemplary block diagram showing a method for controlling sequentially a temperature of a battery system according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles, fuel cell vehicles, and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control mechanism refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control mechanism or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, a temperature control apparatus of a battery system and method for a vehicle according to an exemplary embodiment of the present invention will be described, referring to the accompanying drawings.

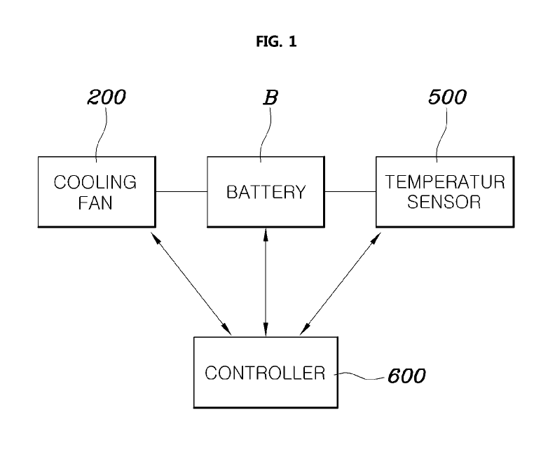

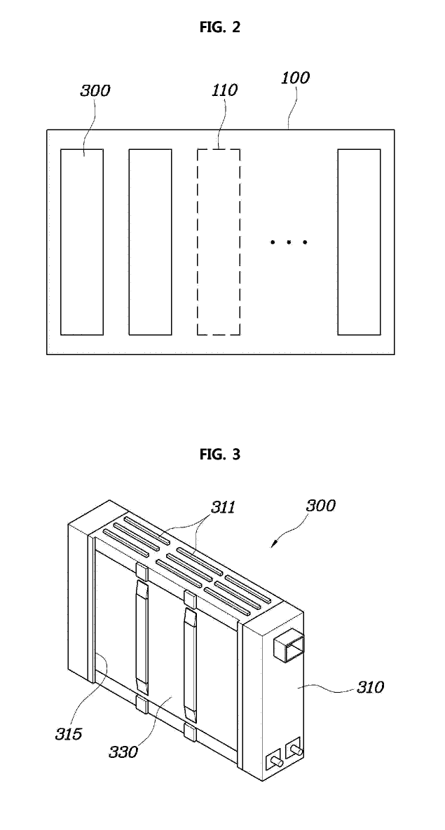

FIG. 1 is an exemplary schematic view showing a battery system according to an exemplary embodiment of the present invention, FIG. 2 is an exemplary detailed view showing a battery B of FIG. 1, and FIG. 3 is an exemplary detailed view showing a battery module 300 of FIG. 2

A temperature control apparatus of a battery system for a vehicle may include: a case 100 in which a plurality of module mounting portions 110 are arranged; a cooling fan 200 installed to one side of the case 100 and allows an air to flow within the case 100; a battery module 300 mounted to the module mounting portion 110 and in which a housing 310 on an upper surface of which air vents 311 formed through is disposed, a plurality of battery cells 330 separately mounted to an inner side of the housing 310 and a predetermined space portion 313 is provided between the battery cells 330 and the housing 310; a driving mechanism 400 disposed at the space portion 313 of the battery module 300 and in which baffles 410 in a shape of plate are formed at locations that correspond to the air vents 311, respectively, wherein the baffle 410 may be connected to an actuator 430 and may be driven by the actuator 430 to close or open the air vent 311; a temperature sensor 500 mounted to a battery module 300 may be configured to measure a temperature thereof; and a controller 600 may be configured to calculate a temperature deviation by identifying a maximum temperature battery module 300 and a minimum temperature battery module 300 based on the temperature measured at the temperature sensor 500 and may be configured to operate a driving mechanism 400 based on the calculated temperature deviation.

In a battery system shown in FIG. 1, a battery B may be formed with a plurality of battery modules 300 and the battery module 300 may be formed with a plurality of battery cells 330. The case 100 refers to a battery case. Additionally, a cooling fan 200 may be disposed at the rear of the case 100 to cool the battery B by suctioning the air into the case 100. A temperature sensor 500 may be mounted to the battery module 300 inside the battery B, however the temperature sensor is shown separately for illustration in the drawings.

FIG. 2 is an exemplary view showing the battery B wherein a plurality of module mounting portions 110 are arranged frontward/rearward to the case 100 and the battery modules 300 may be mounted to the module mounting portions 110, respectively. Further, a layout method of the battery module 300 and the number thereof may be changed without limit according to the design of the system.

FIG. 3 shows an exemplary battery module 300 in which the air vent 311 of a housing 310 of the battery module 300 is slit-shaped in the longitudinal direction of the housing 310 wherein a plurality of the air vents may be spaced at a predetermined interval to form rows and columns and the air within the case 100 may flow to the battery modules 300 via the air vents 311 to cool the battery module. Additionally, the housing 310 may be formed in a shape of a rectangular pole, in which apertures 315 may be formed to have maximum areas at the front and the rear of the housing 310 to expose the surfaces of battery cells 330 disposed on front-most surface and rear-most surface of the housing 310 to the air that flows inside the case 100 without additional devices to improve cooling efficiency of the battery modules 300.

A space portion 313 of the battery modules 300 may be disposed at any of upper side, lower side and both sides of the battery modules 300 based on a design, however, the battery module may be disposed at the upper side, which is shown and described in the present exemplary embodiment. The space portion 313 of the battery modules 300 may be formed upwardly on an upper surface of the battery cell 330, that is, at an inner side of the upper surface of the housing 310, and may require a larger space than the space formed the battery cells 330 and the housing 310 in a conventional battery module 300 and in this case, the upper end of the housing 310 may be formed higher than that of a conventional housing.

A driving mechanism 400 may be disposed at one side of the space portion 313 wherein the driving mechanism 400 may include a plurality of baffles 410 that correspond to the air vents 311, respectively, a link 450 that may connect a plurality of baffles 410, and the actuators 430 that may be connected to the link 450 to drive the link. In particular, the baffles connected to the link 450 may be driven by the actuators 430 to close or open the air vents 311, respectively. The baffles 410 may be operated simultaneously by the link 450 or some of the baffles 410 may be operated, if necessary. Further, as a plurality of baffles 410 may be connected as a single baffle via the link 450, the baffles may be operated with one actuator 430, and thus have an advantage that every baffle 410 does not require an actuator 430.

Additionally, the battery modules 300 may be larger, or the actuators 430 may be provided at both ends of the baffle 410, respectively, to drive the link 450 connected to the actuator 430, to obtain improved operation performance. In addition, the baffles 410 may be formed to be shorter and connected with a plurality of link 450. The driving mechanism 400 may be divided, depending on the movement of the baffle 410, into a sliding type wherein the baffles may be slid forward/rearward (e.g., horizontally) along the linear movement of the link 450 and a hinge type wherein the baffle 410 rotates around the link 450 as a hinge axis.

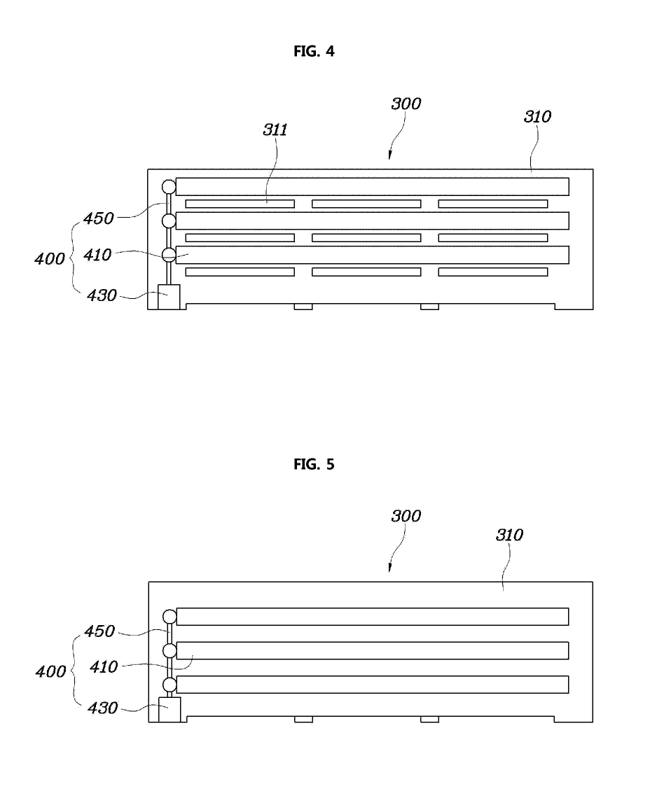

FIG. 4 is an exemplary view showing a sliding type driving mechanism 400 before operation and FIG. 5 is an exemplary view showing a sliding type driving mechanism of FIG. 4 after operation wherein in the sliding type the baffles 410 may be configured to be slid by a linear movement of the link 450 connected to the actuator 430 when the actuator 430 drives, to close or open the air vents 311, and in the sliding type the baffle may be connected to an upper part of the housing 310 of the battery module 300. Specially, for the sliding type driving mechanism 400, a guide groove may be formed on the upper surface or the lower surface of the housing 310 to which the driving mechanism 400 may be mounted for the link 450 to move smoothly within the guide groove.

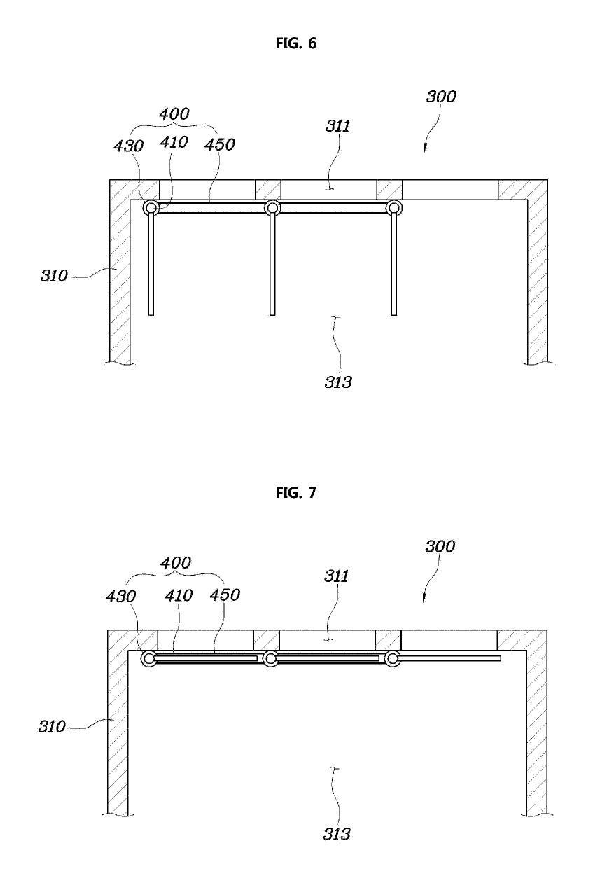

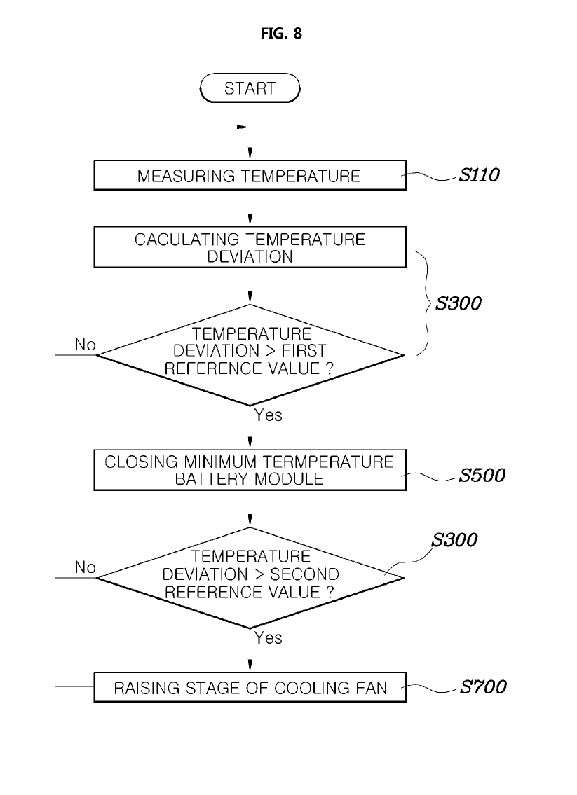

FIG. 6 is an exemplary view showing a hinge type driving mechanism before operation and FIG. 7 is an exemplary view showing a hinge type driving mechanism of FIG. 6 after operation wherein in the hinge type the baffle 410 may be rotated around the link 450 connected to the actuator 430 as a hinge axis when the actuator 430 drives, to close or open the air vents 311, the baffle may be rotated to about 90 degrees.

Specially, in the hinge type driving mechanism 400, the air vents 311 may be closed or opened with one baffle 410, however a rotation radius of the baffle that is determined based on the size of the baffle 410 may increase to require the higher housing 310, and thus one baffle 410 may be used, in consideration of a design of the apparatus.

Furthermore, the temperature sensor 500 may be mounted to each of the battery modules 300 to transfer the measured temperature of each battery module 300 to a controller 600. The controller 600 may be configured to receive the temperature values of each battery module 300 input from the temperature sensor 500, calculate the temperature deviation between two battery modules 300 by identifying a battery module 300 that indicates the highest temperature and a battery module 300 that indicates the lowest temperature by comparing the temperatures of each battery module 300 and then operate the driving mechanism 400 based on the calculated temperature deviation. The calculated temperature deviation may be compared with a first reference value and a second reference value, which have been stored previously in the controller 600, wherein the second reference value is greater than the first reference value and the values may be set arbitrarily depending on the design.

At first, when the calculated temperature deviation between two battery modules 300 is the first reference value or greater, the driving mechanism 400 of the minimum temperature battery module 300 may be operated to close the air vent 311 of the minimum temperature battery module 300 to supply a sufficient amount of air to the remaining battery modules 300 to make a heat equilibrium state inside the battery B within a decreased time period while air is prevented from flowing into the minimum temperature battery module 300. Therefore, overall durability of the battery B may be improved through the improvement of cooling efficiency thereof to block the air that flows into the battery module 300 which is cooled sufficiently by closing the air vents 311 at the side being cooled sufficiently and surplus air may be supplied to the battery modules 300 of high temperature, since the entire battery modules 300 are not available when only a part of the battery modules 300 is maintained at a high temperature and one of battery cells 330 is deteriorated.

Additionally, the controller 600 may be configured to drive the driving mechanism 400 of the minimum temperature battery modules 300 to block the air that flows therein by closing the air vent 311 of the minimum temperature battery modules 300, when the calculated temperature deviation is the second reference value of a predetermined level or greater, which is greater than the first reference value. At the same time a sufficient amount of cooling air may flow into the battery B by raising the stage of the cooling fan 200 to cool the battery B to a predetermined level by one stage or several stages (e.g., power level of the fan) as required, to lower the temperature of the maximum temperature battery modules 300 and maintain a heat equilibrium inside the battery B, thereby protecting the battery B from being deteriorated and enhancing the durability of the entire battery B.

FIG. 8 is an exemplary block diagram showing sequentially a method of controlling the temperature of a battery system of an exemplary embodiment of the present invention in which the method of controlling the temperature of the battery may include: measuring, by a temperature sensor, the temperatures of each battery module S100; identifying, by a controller, a maximum temperature battery module and a minimum temperature module based on the temperature measured in the measurement step S100, calculating, by the controller, a temperature deviation between two battery modules to compare S300 whether the calculated temperature deviation is greater than the first reference value; and operating, by the controller, the driving mechanism of the minimum temperature battery modules to close the air vents, when the temperature deviation calculated in the comparing step S300 is the first reference value or greater S500.

In the measuring step S100, the temperatures of each battery module may be measured with each temperature sensor provided in each battery module. In addition, in the comparing step S300, the temperatures of each battery module measured in the measuring step may be compared by the controller to identify the maximum temperature battery module and the minimum temperature battery module, and then the temperature deviation between two battery modules may be calculated to compare whether the temperature deviation is the first reference value that has been stored in the controller or greater. In the operating step S500, when the temperature deviation between two battery modules is the first reference value or greater in the comparing step S300, the driving mechanism of the minimum temperature battery module may be operated by the controller to close the air vents to allow the cooling air to be flowed into the minimum temperature battery module to flow towards the remaining battery module including the maximum temperature battery module, to reach a heat equilibrium state inside the battery with cooling the battery more rapidly.

Additionally, the comparing step S300 may further include a step of driving the cooling fan to raise the stage thereof when comparing whether the calculated temperature deviation is the second reference value or greater, which is greater than the first reference value, and when the calculated temperature deviation is the second reference value or greater, the stage of the cooling fan may be raised to cool the battery more rapidly.

The driving mechanism that is driven in the operating step S500 may be provided by selecting one of a sliding type and a hinge type, and in the sliding type, the controller may be configured to operate an actuator of the driving mechanism of the minimum temperature battery module in the operating step, allowing the link that is connected to the actuator to be moved linearly and a plurality of baffles that are connected to the link to be slid to close the air vents, thereby blocking the air inflow to the minimum temperature battery module. Additionally, in the hinge type of the driving mechanism, the controller may be configured to operate the actuator of the driving mechanism of the minimum temperature battery module in the operating step, allowing a plurality of baffles that are connected to the link to be rotated around the link that is connected to the actuator as a hinge axis to close the air vents, thereby blocking the air inflow to the minimum temperature battery module.

As described above, according to the temperature control apparatus of a battery system and method for a vehicle, a battery life may be extended by reducing the temperature deviation between battery modules inside a battery or further, the temperature deviation between battery cells to prevent deterioration and the durability deviation in advance between battery cells. Additionally, an error made while estimating State of Charge (SOC), which is caused from the temperature deviation may be reduced, and moreover, a battery power derating (load reducing design) may be available.

Accordingly, battery temperature deviation may be controlled actively despite which cooling structure is used and further the freedom degree of design may increase, and the freedom degree of the mounting may also increase.

While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the accompanying claims.

What is claimed is:

1. A temperature control apparatus of a battery system for a vehicle, comprising:
a case in which a plurality of module mounting portions are disposed;
a cooling fan installed to one side of the case and causes air to flow within the case;
a battery module mounted to the module mounting portion and in which a housing on an upper surface that has air vents is provided, a plurality of battery cells separately mounted to an inner side of the housing and predetermined space portion is disposed between the battery cells and the housing;
a driving mechanism disposed within the space portion of the battery module and in which baffles in a shape of a plate are formed at locations that correspond to the air vents, respectively, wherein each baffle is connected to an actuator and is driven by the actuator to close or open the air vent; and
a temperature sensor mounted to a battery module to measure a temperature thereof, wherein
a controller configured to calculate a temperature deviation by identifying a maximum temperature battery module and a minimum temperature battery module based on the temperature measured with the temperature sensor and operating the driving mechanism based on the calculated temperature deviation.

2. The temperature control apparatus of a battery system for a vehicle of claim 1, wherein each air vent of the housing is slit-shaped in the longitudinal direction of the housing wherein the air vents are spaced separately at a predetermined interval to form rows and columns

3. The temperature control apparatus of a battery system for a vehicle of claim 1, wherein the housing is formed in a shape of a rectangular pole, in which apertures are formed to accommodate the surfaces of the battery cells that are disposed on front-most surface and rear-most surface of the housing to be exposed.

4. The temperature control apparatus of a battery system for a vehicle of claim 1, wherein the space portion of the battery modules is formed between the upper surface of the battery cell and inner side of the upper surface of the housing, and the driving mechanism is disposed at one side of the spacing portion.

5. The temperature control apparatus of a battery system for a vehicle of claim 1, wherein the plurality of baffles that correspond to the air vents are disposed within the driving mechanism, respectively, the plurality of baffles are connected to one another with a link, and the plurality of baffles connected to the link are driven by the actuators to close or open the air vents, respectively.

6. The temperature control apparatus of a battery system for a vehicle of claim 1, wherein the baffles are slid by the linear movement of the link connected to the actuator when the actuator drives, to close or open the air vents.

7. The temperature control apparatus of a battery system for a vehicle of claim 1, wherein the baffles are rotated around the link connected to the actuator as a hinge axis when the actuator drives, to close or open the air vents.

8. The temperature control apparatus of a battery system for a vehicle of claim 1, wherein the controller is configured to operate the driving mechanism of the minimum temperature battery module to close the air vents of the minimum temperature battery module, to block the air inflow therein, when the calculated temperature deviation is a first reference value of a predetermined level or greater.

9. The temperature control apparatus of a battery system for a vehicle of claim 1, wherein the controller is configured to operate the driving mechanism of the minimum temperature battery module to close the air vents of the minimum temperature battery module, to block the air inflow therein, and to raise the stage of the cooling fan to a predetermined level, when the calculated temperature deviation is a second reference value of a predetermined level or greater.

10. The temperature control method of a battery system for a vehicle, comprising:
measuring, by a temperature sensor, the temperatures of battery modules;
identifying, by a controller, a maximum temperature battery module and a minimum temperature battery module based on the measured temperature;
calculating, by the controller, a temperature deviation between two battery modules to compare whether the calculated temperature deviation is greater than the first reference value; and
closing, by the controller, air vents, when the calculated temperature deviation is the first reference value or greater.

11. The temperature control method of a battery system for a vehicle of claim 10, wherein comparing the calculated temperature deviation further includes:
operating, by the controller, a cooling fan to raise a stage thereof when the calculated temperature deviation is the second reference value or greater.

12. The temperature control method of a battery system for a vehicle of claim 11, wherein the second reference value is set to be greater than the first reference value.

13. The temperature control method of a battery system for a vehicle of claim 10, further comprising:
operating, by the controller, the actuator of the driving mechanism to cause the link connected to the actuator to be moved linearly and a plurality of baffles connected to the link to be slid to close the air vents, to block the air inflow.

14. The temperature control method of a battery system for a vehicle of claim 10, further comprising:
operating, by the controller, the actuator of the driving mechanism to cause a plurality of baffles connected to the link to be rotated around the link connected to the actuator as a hinge axis to close the air vents, to block the air inflow.

15. A non-transitory computer readable medium containing program instructions executed by a controller, the computer readable medium comprising:
program instructions that control a temperature sensor to measure the temperatures of battery modules;
program instructions that identify a maximum temperature battery module and a minimum temperature battery module based on the measured temperature;
program instructions that calculate a temperature deviation between two battery modules to compare whether the calculated temperature deviation is greater than the first reference value; and
program instructions that close air vents, when the calculated temperature deviation is the first reference value or greater.

16. The non-transitory computer readable medium of claim 15, further comprising:
program instructions that operate a cooling fan to raise a stage thereof when the calculated temperature deviation is the second reference value or greater.

17. The non-transitory computer readable medium of claim 16, wherein the second reference value is set to be greater than the first reference value.

18. The non-transitory computer readable medium of claim 15, further comprising:
program instructions that operate the actuator of the driving mechanism to cause the link connected to the actuator to be moved linearly and a plurality of baffles connected to the link to be slid to close the air vents, to block the air inflow.

19. The non-transitory computer readable medium of claim 15, further comprising:
program instructions that operate the actuator of the driving mechanism to cause a plurality of baffles connected to the link to be rotated around the link connected to the actuator as a hinge axis to close the air vents, to block the air inflow.
